(19) United States
(12) Patent Application Publication
(10) Pub. No.: US 2021/0302632 A1
(43) Pub. Date: Sep. 30, 2021

(54) FOCUS-CORRECTED OPTICAL FILTER APPARATUS FOR MULTI-WAVELENGTH OPTICAL SYSTEMS

(71) Applicant: CORNING INCORPORATED, Corning, NY (US)

(72) Inventor: David Matthew Berg, Rochester, NY (US)

(21) Appl. No.: 17/206,792

(22) Filed: Mar. 19, 2021

Related U.S. Application Data
(60) Provisional application No. 63/002,468, filed on Mar. 31, 2020.

(51) Int. Cl. G02B 5/20; G02B 7/00; G02B 5/04

(52) U.S. Cl. CPC G02B 5/208; G02B 5/04; G02B 7/006

(57) ABSTRACT

The focus-corrected optical filter apparatus includes multiple optical filter assemblies supported by a movable support member. Each optical filter assembly includes an optical filter and a corrector that form a filter-corrector pair that move together with the support member. Each corrector is formed to compensate for the adverse effects of chromatic aberration of a focusing lens at the given wavelength of the corresponding optical filter in the filter-corrector pair. Example correctors are flat glass plates with different thicknesses. The focus-corrected optical filter apparatus is arranged so that the different optical filter assemblies can be sequentially inserted into the optical path of a focused multi-wavelength light beam to sequentially form substantially monochromatic focused light beams having the different wavelengths but have the same focus position.

This application claims the benefit of priority of U.S. Provisional Application Ser. No. 63/002,468 filed on Mar. 31, 2020, the content of which is relied upon and incorporated herein by reference in its entirety.

### FIELD

The present disclosure relates to optical filter assemblies used in multi-wavelength optical systems, and in particular relates to a focus-corrected optical filter apparatus for multi-wavelength optical systems.

### BACKGROUND

Certain types of optical systems employ light sources that emit light beams having multiple wavelengths. The use of multiple wavelengths in optical systems can give rise to what is known in the art as chromatic aberration, which is a difference in the focus (or image) position as a function of wavelength.

Furthermore, certain types of multi-wavelength optical systems employ optical filters so that one wavelength (or a narrow wavelength band) can be used at a time. An example of such an optical system is an evanescent prism-coupling spectroscopy (EPCS) system used to characterize stress of chemically strengthened articles. In such systems, optical filters are used to filter input light to perform sequential imaging at different wavelengths as defined by the bandpass of each optical filter. The different wavelengths, even when used sequentially, can still give rise to the above-mentioned chromatic aberration, which needs to be corrected to form a proper image at each of the wavelengths. Such chromatic correction has historically resulted in the multi-wavelength optical system having increased complexity and expense while also and being less compact. In cases where the range of wavelengths used is relatively wide, standard optical techniques, such as achromatized lenses, are not available.

### SUMMARY

The focus-corrected optical filter apparatus disclosed herein includes multiple optical filter assemblies supported by a movable support member. Each optical filter assembly includes an optical filter and a corrector that form a filter-corrector pair that move together with the support member. Each corrector is formed to compensate for the adverse effects of chromatic aberration of a focusing lens at the given wavelength of the corresponding optical filter in the filter-corrector pair. Example correctors are flat glass plates with different thicknesses. The focus-corrected optical filter apparatus is arranged so that the different optical filter assemblies can be sequentially inserted into the optical path of a focused multi-wavelength light beam to sequentially form substantially monochromatic light beams having the different wavelengths but have the same focus (image) position.

An embodiment of the disclosure is directed to a focus-correcting optical filter apparatus for correcting a focus error between sequentially generated substantially monochromatic light beams from a focused polychromatic light beam, comprising: a movable support member; a plurality of optical filter assemblies operably supported by the movable support member, with the optical filter assemblies each comprising an optical filter and a corrector optically aligned thereto to form a plurality of filter-corrector pairs, with each optical filter configured to transmit a wavelength of the focused polychromatic light beam substantially different than the other optical filters, and wherein each corrector substantially corrects for the focus error for the wavelength transmitted by the corresponding optical filter in the given filter-corrector pair; and a drive system mechanically coupled to the movable support member and configured to move the movable support member to sequentially insert the plurality of optical filter assemblies into the focused polychromatic light beam to form the sequentially generated substantially monochromatic light beams having substantially different wavelengths and a common focus.

Another embodiment of the disclosure is directed to a focus-correcting optical filter apparatus for correcting a focusing error between first and second substantially monochromatic focused light beams having respective first and second wavelengths and formed from a focused polychromatic light beam comprising the first and second wavelengths, the apparatus, comprising: first and second optical filter assemblies respectively comprising first and second axes and first and second optical filters respectively arranged along the first and second axes and configured to respectively transmit substantially only the first and second wavelengths of the focused polychromatic light beam; a movable support member that supports the first and second filter assemblies in operable relation to the focused polychromatic light beam to allow for the first and second optical filter assemblies to be sequentially inserted into the focused polychromatic light beam when moving the movable support member to sequentially form the first and second substantially monochromatic light beams; the first optical filter assembly further comprising a first corrector disposed along the first axis and in a fixed relation to the first optical filter so that the first optical filter and the first corrector move together when moving the movable support member, wherein the first corrector substantially corrects the focusing error between the first and second substantially monochromatic focused light beams; and a drive system mechanically coupled to the movable support member and configured to move the movable support member to sequentially insert the first and second optical filter assemblies into the focused polychromatic light beam to form the first and second substantially monochromatic light beams having substantially different wavelengths.

Another embodiment of the disclosure is directed to a method of correcting a focusing error between first and second substantially monochromatic focused light beams having respective first and second wavelengths and formed from a focused multi-wavelength light beam comprising the first and second wavelengths, the method comprising: a) forming the first substantially monochromatic focused light beam by moving a first optical filter into the focused multi-wavelength light beam to transmit substantially only the first wavelength of the focused multi-wavelength light beam, wherein the first substantially monochromatic light beam focuses at a first focus position; and b) forming the second substantially monochromatic focused light beam by moving a second optical filter and a second corrector together as a pair into the focused multi-wavelength light beam to transmit substantially only the second wavelength of the focused multi-wavelength light beam, wherein the second substantially monochromatic light beam would focus at a second focus position substantially different from the first position using only the second optical filter, and wherein the corrector causes the second focus position to reside substantially at the first focus position.

According to aspect (1), a focus-correcting optical filter apparatus for correcting a focus error between sequentially generated substantially monochromatic light beams from a focused polychromatic light beam is provided. The focus-correcting optical filter apparatus comprises: a movable support member; a plurality of optical filter assemblies operably supported by the movable support member, with the optical filter assemblies each comprising an optical filter and a corrector optically aligned thereto to form a plurality of filter-corrector pairs, with each optical filter configured to transmit a wavelength of the focused polychromatic light beam substantially different than the other optical filters, and wherein each corrector substantially corrects for the focus error for the wavelength transmitted by the corresponding optical filter in the given filter-corrector pair; and a drive system mechanically coupled to the movable support member and configured to move the movable support member to sequentially insert the plurality of optical filter assemblies into the focused polychromatic light beam to form the sequentially generated substantially monochromatic light beams having substantially different wavelengths and a common focus.

According to aspect (2), the focus-correcting optical filter apparatus according to aspect (1) is provided, further comprising a plurality of glass plates each having planar opposite surfaces, an axial thickness, and an index of refraction, with each corrector comprising one of the plurality of glass plates, wherein at least one of the axial thickness and the index of refraction differ between each of the glass plates.

According to aspect (3), the focus-correcting optical filter apparatus according to aspect (1) or (2) is provided, wherein at least one of the correctors comprises a glass plate having a surface with a radius of curvature with a magnitude greater than 500 mm.

According to aspect (4), the focus-correcting optical filter apparatus according to any of aspects (1) to (3) is provided, wherein the optical filter comprises a multilayer thin-film formed directly on a surface of the corrector.

According to aspect (5), the focus-correcting optical filter apparatus according to any of aspects (1) to (4) is provided, further comprising an additional optical filter assembly that comprises an optical filter but that does not comprise a corrector.

According to aspect (6), the focus-correcting optical filter apparatus according to any of aspects (1) to (5) is provided, wherein each of the optical filter assemblies comprises a support frame that supports the corresponding optical filter and corrector.

According to aspect (7), the focus-correcting optical filter apparatus according to any of aspects (1) to (6) is provided, wherein the movable support member and the plurality of optical filter assemblies constitute an optical filter wheel.

According to aspect (8), the focus-correcting optical filter apparatus according to any of aspects (1) to (7) is provided, wherein the focused polychromatic light beam comprises an ultraviolet wavelength, a visible wavelength and an infrared wavelength.

According to aspect (9), the focus-correcting optical filter apparatus according to any of aspects (1) to (8) is provided, further comprising: a focusing lens configured to receive reflected light reflected from an interface formed by a coupling prism and a waveguide of a chemically strengthened article to form the focused polychromatic light beam, wherein the reflected light contains information about a guided mode spectrum of the waveguide at each of the substantially different wavelengths of the substantially monochromatic light beams.

According to aspect (10), a focus-correcting optical filter apparatus for correcting a focusing error between first and second substantially monochromatic focused light beams having respective first and second wavelengths and formed from a focused polychromatic light beam comprising the first and second wavelengths is provided. The focus-correcting optical filter apparatus comprises: first and second optical filter assemblies respectively comprising first and second axes and first and second optical filters respectively arranged along the first and second axes and configured to respectively transmit substantially only the first and second wavelengths of the focused polychromatic light beam; a movable support member that supports the first and second filter assemblies in operable relation to the focused polychromatic light beam to allow for the first and second optical filter assemblies to be sequentially inserted into the focused polychromatic light beam when moving the movable support member to sequentially form the first and second substantially monochromatic light beams; the first optical filter assembly further comprising a first corrector disposed along the first axis and in a fixed relation to the first optical filter so that the first optical filter and the first corrector move together when moving the movable support member, wherein the first corrector substantially corrects the focusing error between the first and second substantially monochromatic focused light beams; and a drive system mechanically coupled to the movable support member and configured to move the movable support member to sequentially insert the first and second optical filter assemblies into the focused polychromatic light beam to form the first and second substantially monochromatic light beams having substantially different wavelengths.

According to aspect (11), the focus-correcting optical filter apparatus according to aspect (10) is provided, wherein the first corrector comprises a glass plate having substantially planar surfaces, a thickness, and an index of refraction, and wherein at least one of the thickness and the index of refraction is selected to correct the focusing error.

According to aspect (12), the focus-correcting optical filter apparatus according to aspect (10) is provided, wherein the first corrector comprises a glass element having a thickness, a substantially planar surface, and a curved surface, wherein the thickness, the index of refraction, and the curved surface are selected to correct the focusing error, and wherein the curved surface has a radius of curvature with a magnitude greater than 500 mm.

According to aspect (13), the focus-correcting optical filter apparatus according to any of aspects (10) to (12) is provided, wherein the movable support member and first and second filter assemblies comprise either a rotatable filter wheel or a filter bar.

According to aspect (14), the focus-correcting optical filter apparatus according to any of aspects (10) to (13) is provided, wherein the focused polychromatic light beam comprises additional wavelengths, and further comprising corresponding additional filter assemblies each comprising an additional optical filter and an additional corrector, wherein each additional corrector is configured to correct additional focusing errors between additional substantially monochromatic light beams respectively having the additional wavelengths when the additional filter assemblies are sequentially inserted into the focused polychromatic light beam.

According to aspect (15), the focus-correcting optical filter apparatus according to any of aspects (10) to (14) is provided, wherein the focused polychromatic light beam comprises an ultraviolet wavelength, a visible wavelength and an infrared wavelength.

According to aspect (16), the focus-correcting optical filter apparatus according to any of aspects (10) to (15) is provided, further comprising: a focusing lens configured to receive reflected light reflected from an interface formed by a coupling prism and a waveguide of a chemically strengthened article to form the focused polychromatic light beam, wherein the reflected light contains information about a guided mode spectrum of the waveguide at each of the first and second wavelengths of the first and second substantially monochromatic focused light beams.

According to aspect (17), a method of correcting a focusing error between first and second substantially monochromatic focused light beams having respective first and second wavelengths and formed from a focused multi-wavelength light beam comprising the first and second wavelengths is provided. The method comprises: a) forming the first substantially monochromatic focused light beam by moving a first optical filter into the focused multi-wavelength light beam to transmit substantially only the first wavelength of the focused multi-wavelength light beam, wherein the first substantially monochromatic light beam focuses at a first focus position; and b) forming the second substantially monochromatic focused light beam by moving a second optical filter and a second corrector together as a pair into the focused multi-wavelength light beam to transmit substantially only the second wavelength of the focused multi-wavelength light beam, wherein the second substantially monochromatic light beam would focus at a second focus position substantially different from the first position using only the second optical filter, and wherein the corrector causes the second focus position to reside substantially at the first focus position.

According to aspect (18), the method according to aspect (17) is provided, wherein the focused multi-wavelength light beam comprising a third wavelength, and further comprising: c) forming a third substantially monochromatic focused light beam by moving a third optical filter and third corrector together as a pair into the focused multi-wavelength light beam to transmit substantially only the third wavelength of the focused multi-wavelength light beam, wherein the third substantially monochromatic light beam would focus at a third focus position substantially different from the first position using only the third optical filter, and wherein the third corrector causes the third focus position to reside substantially at the first focus position.

According to aspect (19), the method according to aspect (17) or (18) is provided, wherein the second corrector comprises a glass plate having substantially planar opposite surfaces, a refractive index, and a thickness, wherein at least one of the refractive index and the thickness is selected to cause the second focus position to reside substantially at the first focus position.

According to aspect (20), the method according to any of aspects (17) to (19), further comprising: directing multi-wavelength light to be incident upon an interface between a coupling prism and a waveguide of a chemically strengthened article to form a reflected multi-wavelength light beam that includes mode spectrum information about the waveguide at each of the first and second wavelengths; and focusing the reflected multi-wavelength light beam using a focusing lens to form the focused multi-wavelength light beam.

Additional features and advantages are set forth in the Detailed Description that follows, and in part will be apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description explain principles and operation of the various embodiments. As such, the disclosure will become more fully understood from the following Detailed Description, taken in conjunction with the accompanying Figures, in which:

FIG. 1 is a schematic diagram of an example multi-wavelength optical system in the form of an evanescent prism-coupling system (EPCS) used to measure stress in chemically strengthened (CS) articles.

FIG. 2 is an elevated view of an example of a CS article, with local Cartesian coordinates (x, y, z) shown for reference.

FIG. 3 is a schematic diagram of an example light source emitter having three different light source elements that respectively emit in the ultraviolet (UV), infrared (IR) and visible or “white light” (W) to form relatively broad band measurement light.

FIG. 4 is a schematic diagram of an example mode spectrum as detected by the EPCS of FIG. 1.

FIGS. 5A and 5B are schematic diagrams of an example focus-corrected optical filter apparatus that includes a filter wheel that supports multiple optical filter assemblies configured to correct for chromatic aberration caused by using a refractive focusing lens to focus different wavelengths of light.

FIG. 6 is a front-on view of an example filter wheel having by way of example four different optical filter assemblies.

FIG. 7 is a plot of wavelength λ (nm) versus the axial focus shift Δf (mm) for an example singlet focusing lens made of N-BK7 glass and having a focal length f of 150 mm, over a light-source wavelength band from λ_{L}=365 nm to λ_{U}=800 nm.

FIG. 8A is a partially exploded elevated view and FIG. 8B is a close-up cross-sectional view of an example optical filter assembly showing an optical filter and a corrector supported by either a support frame or supported directly by the support member of the filter wheel.

FIG. 8C is similar to FIG. 8B and illustrates an embodiment where the multilayer thin-film that defines the filter bandpass is formed directly on the corrector, thereby obviating the need for the filter substrate.

FIG. 9A shows an example set of m optical filter assemblies, with one of the optical filter assemblies having just an optical filter and no corrector while the other optical filter assemblies respectively have optical filters and correctors with different axial thicknesses.

FIG. 9B is similar to FIG. 9A and illustrates an example set of m optical filter assemblies where the optical filter and the corrector in a given filter-corrector pair are spaced apart.

FIG. 9C is similar to FIG. 9A and illustrates an example set of m optical filter assemblies where the back surfaces of some of the correctors are curved.

FIG. 10 is similar to FIG. 5A and illustrates an alternate configuration for driving the rotation of the filter wheel.

FIGS. 11A and 11B are schematic diagrams of an example focus-corrected optical filter apparatus that uses a filter bar that moves linearly.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

Cartesian coordinates are shown in some of the Figures for the sake of reference and are not intended to be limiting as to direction or orientation.

The acronym “IOX” stands for “ion exchange” or “ion exchanged,” depending on the context of the discussion.

In the Figures, light travels generally from right to left unless otherwise noted.

The term “wavelength” is denoted by λ and in some cases refers to a center wavelength of a relatively narrow band of wavelengths. A light beam that is referred to as being “substantially monochromatic” has a center wavelength and a narrow band of wavelengths about the center wavelength, e.g., a bandwidth δλ of about 2 nm.

A wavelength that is “substantially different” from another wavelength is one that is different by at least the bandwidth of a given optical filter, e.g., greater than 2 nm, and more preferably is different by at least five times the bandwidth of a given optical filter, e.g., greater than 10 nm.

The term “focus corrected” means that the different substantially monochromatic focused light beams having different wavelengths have the same or a common focus (i.e., a same or common axial focus position) or form an image at a same axial location to within a depth of focus of the optical element used to focus (or form an image with) the light beams. Since depth of focus depends on wavelength, the depth of focus can be for one of the wavelengths of the light beams. In an example, the focus correction is to within a depth of focus of the focusing lens used to form the focused light beams.

The term “light-source wavelength band” is denoted B and represents a range of wavelengths from a lower (smallest) wavelength λ_{L} to an upper (greatest) wavelength λ_{U}. The light-source wavelength band B of the initially generated measurement light discussed herein is sufficiently large to be considered polychromatic.

The terms “light-source bandwidth” is denoted Δλ_{S} and is a measure of the distance between upper and lowest wavelengths of the light-source wavelength band, i.e., Δλ_{S}=λ_{U}−λ_{L} for a given light-source wavelength band B.

The acronym “CS” when used to described a type of article (as in “CS article”) means “chemically strengthened.” The term “strengthened” for the CS articles considered herein means that the original CS articles have undergone a process to create some stress profiles that could have a variety of shapes, typically intended to make the CS articles stronger and thus harder to break. Example strengthening processes include IOX processes, tempering, annealing and like thermal processes carried out in glass-based substrates.

The abbreviation “ms” stands for “millisecond.”

The abbreviation “nm” stands for “nanometer.”

The abbreviation “mm” stands for “millimeter.”

In an example, a glass-based substrate is used to form the CS article. The term “glass-based substrate” as used herein includes any object made wholly or partly of glass, such as laminates of glass and non-glass materials, laminates of glass and crystalline materials, and glass-ceramics (including an amorphous phase and a crystalline phase). Thus, in an example, the glass-based substrate can consist entirely of a glass material while in another example can consist entirely of a glass-ceramic material.

The term “corresponding” when referring to an optical filter and a corrector means the optical filter and corrector of a given filter-corrector pair in a given optical filter assembly.

U.S. Patent Application Ser. No. 62/940,295, filed on Nov. 26, 2019 and entitled “Prism-coupling systems and methods having multiple light sources with different wavelengths,” is incorporated by reference herein in its entirety.

Prism-Coupling System

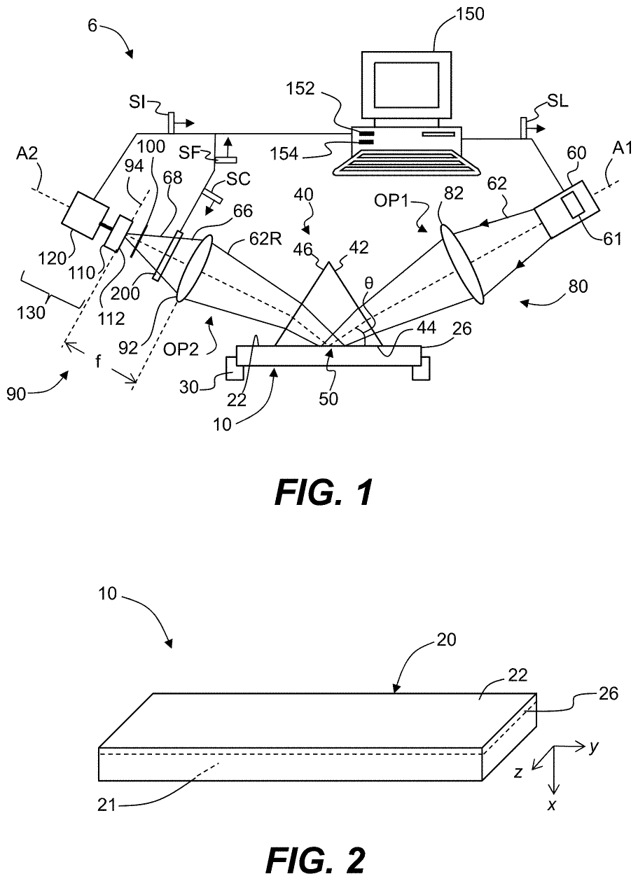

FIG. 1 is a schematic diagram of an example multi-wavelength optical system in the form of an evanescent prism coupling spectroscopy (EPCS) system 6 used to measure stress in chemically strengthened (CS) articles and that serves as the basis for explaining aspects of the focus-corrected optical filter apparatus disclosed herein. Reference is thus made to the EPCS system 6 in the discussion below. It is noted that the focus-corrected optical filter apparatus disclosed herein is applicable for use in other types of multi-wavelength optical systems and that the application of the focus-corrected optical filter apparatus to an EPCS system is chosen as an illustrative example and for ease of explanation and context.

FIG. 2 is an elevated view of an example of a CS article 10, with local Cartesian coordinates (x, y, z) shown for reference. The CS article 10 comprises a glass-based substrate 20 having a matrix 21 that defines a (top) surface 22. The matrix has a base (bulk) refractive index nₛ and a surface refractive index n₀ as defined by a refractive index profile n(x) that can be formed using an IOX process for example. The refractive index profile n(x) forms a near-surface optical waveguide (“waveguide”) at or immediately adjacent the surface 22. The IOX process provides chemical strengthening of the glass-based substrate 20 by causing stress within the near-surface region that defines the waveguide 26. Characterization of the stress profile and related stress characteristics within the glass-based substrate (knee stress, compressive stress at the surface, center tension, birefringence, etc.) can be used to control the chemical strengthening process to optimally form CS articles 10.

With reference again to FIG. 1, the EPCS system 6 includes a support stage 30 configured to operably support the CS article 10. The EPCS system 6 also includes a coupling prism 40 that has an input surface 42, a coupling surface 44 and an output surface 46. The coupling prism 40 has a refractive index n_{P}>n₀. The coupling prism 40 is interfaced with the CS article 10 being measured by bringing coupling-prism coupling surface 44 and the surface 22 into optical contact, thereby defining an interface 50 that in an example can include an interfacing (or index-matching) fluid (not shown).

The EPCS system 6 includes input and output optical axes A1 and A2 that respectively pass through the input and output surfaces 42 and 46 of the coupling prism 40 and that generally converge at the interface 50 after accounting for refraction at the prism/air interfaces.

The EPCS system 6 further includes, in order along the input optical axis A1, a light source system 60 that includes a light-source emitter 61 that emits a measurement light beam 62 in the general direction along the input optical axis A1. In one example, the light source emitter 61 is configured to generate the measurement light beam 62 so that it includes multiple wavelengths within a relatively wide (e.g., several hundred nanometer) light-source wavelength band B. Such a light beam is also referred to as a polychromatic light beam. An example focused polychromatic light beam 62 comprises ultraviolet, visible and infrared wavelengths. The light source system 60 can include other optical and electrical elements (not shown) as known in the art.

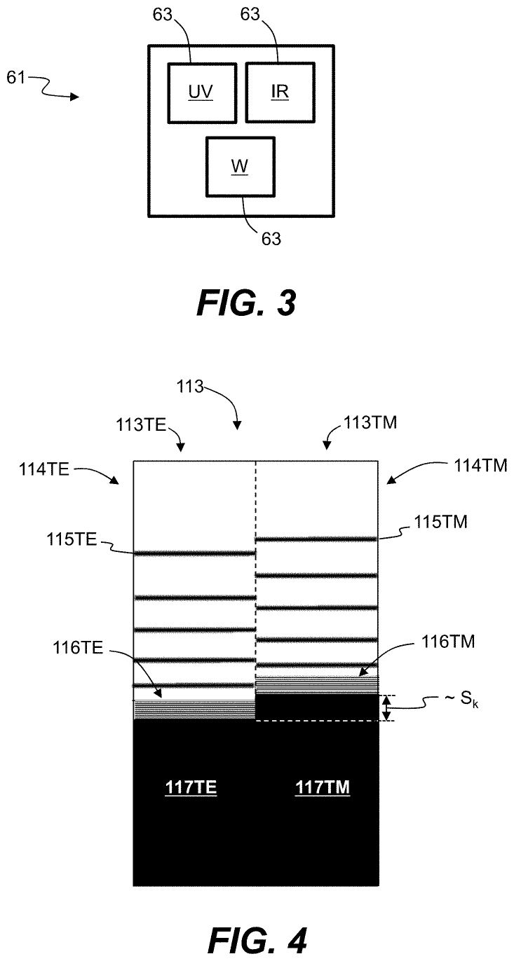

FIG. 3 is a schematic diagram of an example light-source emitter 61 that comprises three different light-source elements 63, with one denoted “UV” for ultraviolet light, one denoted “IR” for infrared light, and one denoted “W” for white light. A collective or total light-source wavelength band B of the light-source emitter 61 is formed by the combination of the output light from the three different light-source elements 63. In an example, the upper (largest) wavelength λ_{U} is about 800 nm and a lower (smallest) wavelength λ_{L} is about 360 nm, which represents a total light-source wavelength bandwidth Δλ_{S} of about 440 nm. Not all wavelengths within the light-source wavelength band B have the same intensity. The wavelength profile or spectrum of the light source system 60 can be tailored based on the types, combinations and numbers of the light-source elements 63 used to form the light-source emitter 61.

With reference again to FIG. 1, the input optical axis A1 runs between the light source system 60 and the coupling prism 40. A focusing optical system 80 that includes a focusing lens 82 is used to focus the measurement light beam 62 so that interacts with the waveguide 26 of the CS substrate 10 and results in reflected light beam 62R, as explained in greater detail below. The input optical axis A1 defines the center of an input optical path OP1 between the light source system 60 and the coupling surface 44. The input optical axis A1 also defines a coupling angle θ with respect to the interface 50.

The EPCS system 6 also includes, along the output optical axis A2 from the coupling prism 40, a collection optical system 90 that receives the reflected light beam 62R and forms a focused (reflected) light beam 66. The collection optical system 90 comprises a focusing lens 92 having a focal plane 94 and a focal length f, which is wavelength dependent. The collection optical system 90 also includes a focus-corrected optical filter apparatus 200 (discussed in greater detail below), a TM/TE polarizer 100, and a photodetector system 130. When the focused light beam 66 passes through the optical filter apparatus, it becomes filtered focused light beam 68, as explained below. The TM/TE polarizer 100 is relatively thin and does not cause any substantial adverse optical effects such as chromatic aberration, distortion, etc.

The output optical axis A2 defines the center of an output optical path OP2 between the interface 50 and the photodetector system 130. In an example, the photodetector system 130 includes a detector (camera) 110 with a photosensitive surface 112, and a frame grabber 120. In other embodiments discussed below, the photodetector system 130 includes a CMOS or CCD camera. The TM/TE polarizer 100 effectively splits the photosensitive surface 112 into TE and TM sections, which allows for the simultaneous recording of digital images of the angular reflection spectrum (mode spectrum) 113, which includes the individual TE and TM mode spectra for the TE and TM polarizations of the detected light. This simultaneous detection eliminates a source of measurement noise that could arise from making the TE and TM measurements at different times, given that system parameters can drift with time.

The photosensitive surface 112 is disposed in the focal plane 94 of the collecting optical system 90, with the photosensitive surface being generally perpendicular to the output optical axis A2. This serves to convert the angular distribution of the reflected light beam 62R exiting the coupling prism output surface 46 to a transverse spatial distribution of light at the sensor plane of the detector 110. In an example embodiment, the photosensitive surface 112 comprises pixels (not shown), i.e., the detector 110 is a digital detector, e.g., a digital camera. The reflected light beam 62R thus includes information about the mode spectrum due to some of the focused measurement light beam 62 being optically coupled into the guided modes of the waveguide 26.

FIG. 4 is a schematic representation of a mode spectrum 113 as captured by the photodetector system 130 for a given measurement wavelength λ. The mode spectrum 113 includes TE and TM mode spectra 113TE and 113TM, respectively. The TE mode spectrum 113TE has a total-internal-reflection (TIR) section 114TE associated with TE guided modes of the waveguide 26 and a non-TIR section 117TE associated with radiation modes and leaky modes. A transition between the TIR section 114TE and the non-TIR section 117TE defines a TE critical angle and is referred to as the critical angle transition 116TE. Likewise, the TM mode spectrum 113TM has a TIR section 114TM associated with TM guided modes of the waveguide 26 and a non-TIR section 117TM associated with radiation modes and leaky modes. A transition between the TIR section 114TM and the non-TIR section 117TM defines a TM critical angle and is referred to as the critical angle transition 116TM. The (compressive) knee stress Sk is calculated using the difference between the TE and TM critical angle transitions 116TE and 116TM.

The TE mode spectrum 113TE includes mode lines or fringes 115TE while the TM mode spectrum 113TM includes mode lines or fringes 115TM. The mode lines or fringes 115TE and 115TM can either be bright lines or dark lines, depending on the configuration of the EPCS system 6. In FIG. 4, the mode lines or fringes 115TE and 115TM are shown as dark lines for ease of illustration. The term “fringes” is often used as short-hand for the more formal term “mode lines.” Stress characteristics are calculated based on the difference in positions of the TE and TM fringes 115TE and 115TM in the mode spectrum 113.

With reference again to FIG. 1, the EPCS system 6 includes a controller 150, which is configured to control the operation of the EPCS system. The controller 150 is also configured to receive and process from the photodetector system 130 image signals SI representative of captured (detected) TE and TM mode spectra images. The controller 150 is also configured to control the operation of the focus-corrected optical filter apparatus 200 via a control signal SC and also receive a data signal SF from the focus-corrected optical filter apparatus that includes information about the state of the focus-corrected optical filter apparatus, as discussed further below.

The controller 150 includes a processor 152 and a memory unit (“memory”) 154. The controller 150 may control the activation and operation of the light source system 60 via a light-source control signal SL, and receives and processes image signals SI from the photodetector system 130 (e.g., from the frame grabber 120, as shown), and also receives the data signal SF from the focus-corrected optical filter apparatus. The controller 150 is programmable (e.g., with instructions embodied in a non-transitory computer-readable medium) to perform the functions described herein, including controlling the operation of the EPCS system 6 and performing the aforementioned signal processing of the image signals SI and data signal SF to arrive at a measurement of one or more of the aforementioned stress characteristics of the CS article 10.

Focus-Corrected Optical Filter Apparatus

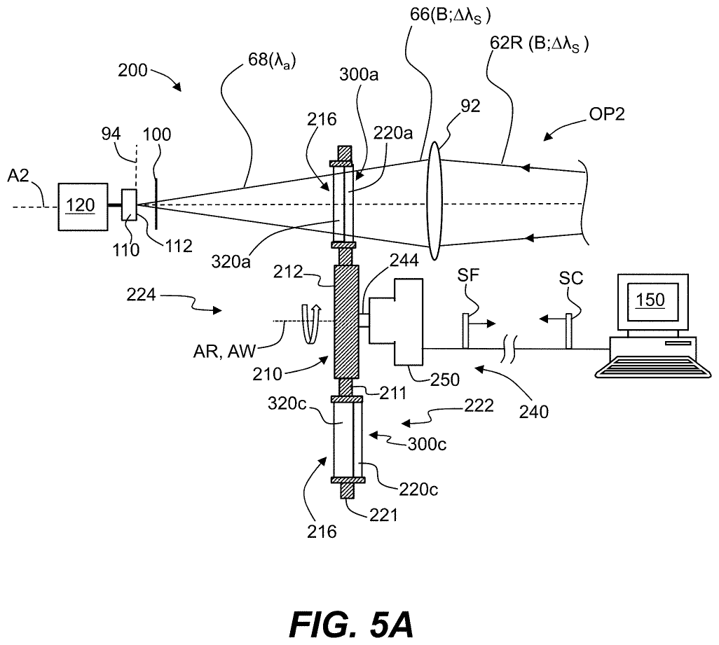

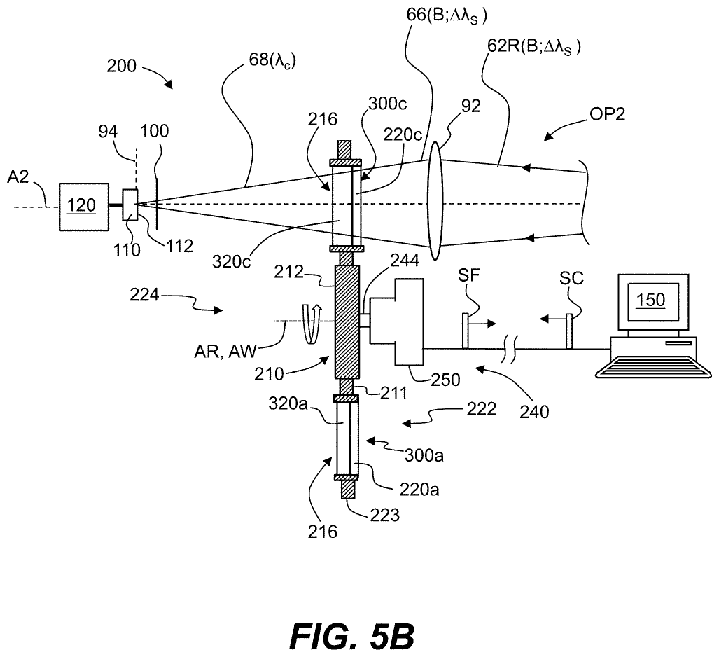

FIG. 5A is a side view of an example of the focus-corrected optical filter apparatus 200 as discussed herein and as used in the EPCS system 6 described above. FIG. 5B is similar to FIG. 5A and is discussed further below.

With reference to FIG. 5A, the focus-corrected optical filter apparatus 200 comprises a support member 210 that operably supports in two or more apertures 216 respective two or more optical filter assemblies 300, which are denoted 300a, 300b, . . . 300m for an integer number m of optical filter assemblies. The different optical filter assemblies 300a, 300b, . . . 300m are configured to perform optical filtering at respective filter wavelengths λₐ, λ_{b}, λ_{c}, . . . λₘ having respective relatively narrow bandwidths δλₐ, δλ_{b}, δλ_{c}, . . . δλₘ of 2 nm for example. At the moment in time shown in FIG. 5A, the focus-corrected optical filter apparatus 200 is positioned to perform optical filtering at the filter wavelength λₐ by directing the focused reflected light beam 66 through the optical filter assembly 300a to form focused and filtered reflected light beam 68 having the filter wavelength λₐ. In this manner, the multi-wavelength reflected measurement light beam 62R becomes substantially monochromatic (filtered) measurement light beam 68 of a select wavelength based on the filter through which the focused reflected light beam 66 passes.

The notation “66(B; Δλ_{S})” etc. is used below as a shorthand way of indicating that the focused reflected light beam is multi-wavelength, having the light-source wavelength band B and the light-source wavelength bandwidth Δλ_{S}. Likewise, the notation “68(λₐ)” etc. is a shorthand way of indicating that the filtered and focused reflected light beam is substantially monochromatic, having the filtered wavelength λₐ (with the attendant narrow bandwidth of δλₐ being implied). In the discussion below, the light beams 66 and 68 are respectively referred to as “focused” and “filtered” light beams for ease of discussion.

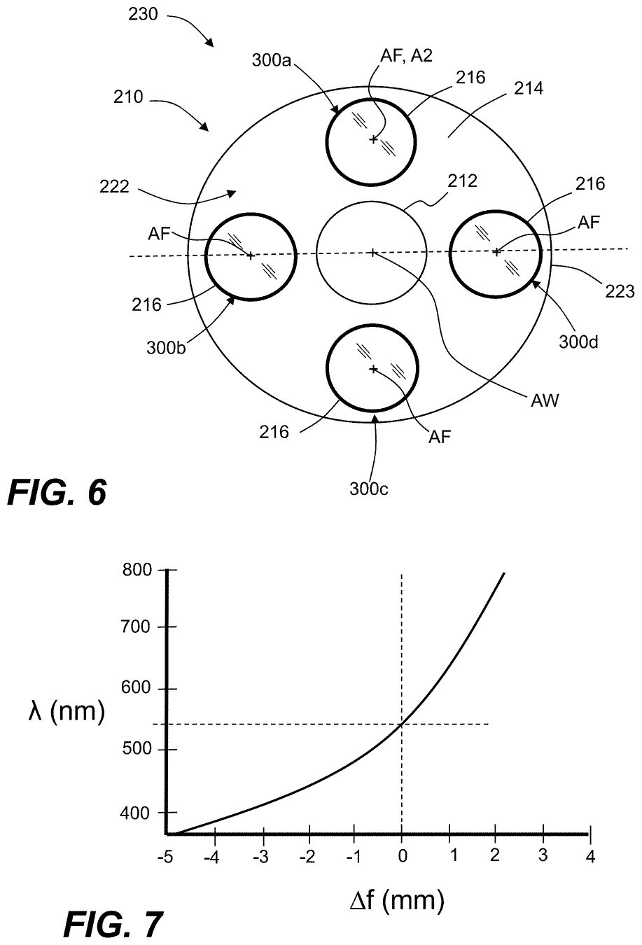

FIG. 6 is a front-on view of an example support member 210 supporting four different optical filter assemblies 300 (300a, 300b, 300c and 300d) having respective filter wavelengths of λₐ, λ_{b}, λ_{c} and λ_{d}. The example support member 210 of FIG. 6 has a circular disc-shaped body 211 with a central axis AW, a central section 212 and an outer section 214, with the optical filter assemblies being supported in the outer section, and in an example evenly distributed thereover. The support member 210 also has an outer perimeter 223, a front side 222 and a back side 224. The central axis AW runs through the center section 212 of support member body 211 as shown. The combination of the support member 210 and optical filter assemblies 300 constitute a filter wheel 230. The optical filter assembly 300a is shown centered on the second optical axis A2 of the EPCS system 6, i.e., the axis AF of the optical filter assembly 300a is coaxial with the second optical axis A2 of the EPCS system 6.

With reference again to FIG. 5A, a drive system 240 is mechanically connected to the support member 210 and is configured to cause the movement of the support member. An example drive system comprises a drive shaft 244 having one of its ends attached to the central section 212 of the support member 210 while its other end is attached to a drive motor 250. The drive shaft 244 is disposed co-axially with the support member axis AW. The drive motor is electrically connected to the controller 150, which is configured (e.g., using control software) to control the operation of the drive motor 250 using the control signal SC while also receiving the data signal SF that includes information about the motor operation, such as the rotation rate, the relative rotational position of the filter wheel 230, etc.

The drive system 240 causes the filter wheel 230 to rotate about a rotation axis AR that is coaxial with the support member axis AW. The filter wheel 230 is in turn disposed such that the optical filter assemblies 300 sequentially intersect the output optical axis A2 downstream of the focusing lens 92 and at substantially a right angle during the rotation of the filter wheel. Thus, the focused light beam 66 is sequentially filtered by each optical filter assembly 300 to form sequentially filtered light beams 68. The filtered light beams 68 for each filter wavelength are then detected sequentially by the photodetector system 130 as described above to capture mode spectrum images.

FIG. 5B is similar to FIG. 5A and shows a point later in time where the filter wheel has rotated so that the optical filter assembly 300c is in the optical path OP2 of the focused light beam 66 so that this light passes through the optical filter assembly 300c and forms the filtered light beam 68(λ_{c}) having the filter wavelength λ_{c} The filtered light beam 68(λ_{c}) is focused substantially at the image plane 94 and thus substantially at the detector 100 (e.g., to within the depth of focus of focusing lens 92), thereby substantially eliminating the chromatic aberration generated by the focusing lens. This same focus-correcting effect occurs with the other optical filter assemblies 300 in the filter wheel 230.

FIG. 7 is a plot of wavelength λ (nm) versus the axial focus shift Δf (mm) for an example singlet focusing lens 92 made of N-BK7 glass and having a focal length f of 150 mm at a wavelength of 545 nm. The light-source wavelength band B is from λ_{L}=365 nm to λ_{U}=800 nm, which is typical for the light source system 60. The total difference in focus distance is about 7 mm over this wavelength band while the depth of focus (DOF) of the singlet focusing lens 92 is about 0.1 mm. Best focus is set at 545 nm in the plot, but could be set at any other wavelength. In one example, an image at one extreme wavelength (e.g. λ_{U}=800 nm) is correctly focused (formed) at the image plane 94 while the image from the other extreme wavelength (λ_{L}=365 nm) is grossly out of focus, which represents extreme amounts of chromatic aberration. Even with the best focus set at about the middle of the light-source wavelength band B as shown in FIG. 7, the amount of chromatic aberration is still so large that it cannot be adequately corrected using an achromatic doublet lens as the focusing lens 92.

Optical Filter Assemblies

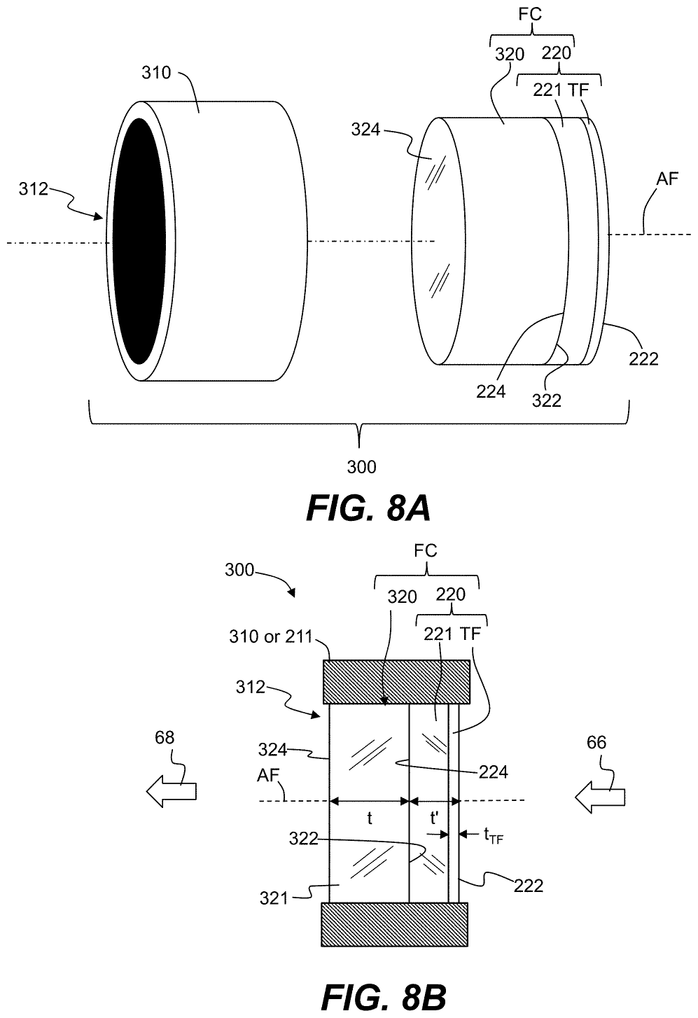

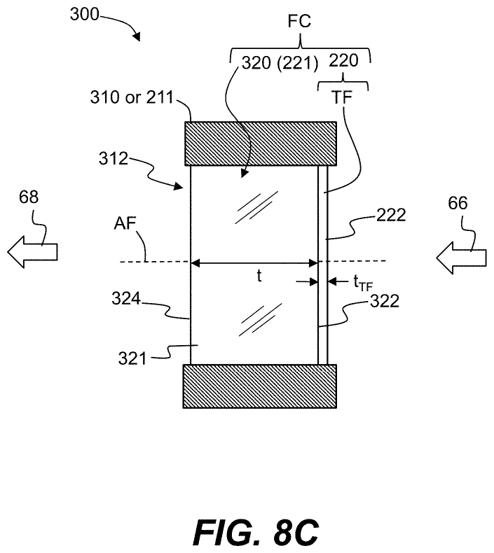

FIG. 8A is a partially exploded elevated view and FIG. 8B is a cross-sectional view of an example optical filter assembly 300. The optical filter assembly 300 has a central axis AF and includes an optical filter 220 and a correcting member (“corrector”) 320 arranged in close proximity along the filter axis AF. The optical filter 220 has a front surface 222 and a back surface 224. The optical filter 220 comprises a multilayer thin-film TF that defines the front surface and also includes a filter substrate 221 of thickness t′ that supports the multilayer thin-film. The multilayer thin-film TF has a thickness t_{TF} that is much smaller than the thickness t′ of the filter substrate t′ (i.e., t′>>t_{TF}), and typically comprises tens or hundreds of dielectric layers.

The corrector 320 has a front surface 322 and a back surface 324 and an axial thickness t. The front surface of the corrector 320 resides either in contact with or in close proximity to the back surface 324 of the optical filter. In an example, t>>t′ so that the thicknesses t′ and t_{TF} can be ignored when selecting the thickness t as described below. The direction of light travel of the focused light beam 66 and of the resulting filtered light beam 68 are shown in FIG. 8B by corresponding arrows for reference. In the examples shown, the optical filter 220 is optically upstream of the corrector, i.e., the focused light beam 66 is first incident upon the optical filter 220. In another non-illustrated example, the optical filter 220 is optically downstream of the corrector 320. In both cases the operation is the same. The optical filter 220 and corrector 320 of a given optical filter assembly 300 constitute a filter-corrector pair FC (see FIG. 8A).

FIG. 8C is a cross-sectional view similar to that of FIG. 8B that shows an example where the multilayer thin-film TF is formed directly on the front surface 322 of the corrector 320, thereby obviating the need for the filter substrate 221. In this example, the optical filter 220 can be thought of as constituted by the multilayer thin-film TF only, with t′=0. In the example configuration of FIG. 8B, the corrector 320 also performs the role of the filter substrate 221.

The optical filter 220 and corrector 320 can be supported as a filter-corrector pair FC by a support frame 310, which in turn can be incorporated into the filter wheel 230 at a given one of the apertures 216. The support frame 310 can be of the type used in the art to hold optical filters, lenses and like optical components. The support frame 310 shown in FIGS. 8A and 8B for example is a ring-type holder having an interior 312 configured to hold the optical filter 220 and corrector 320.

In another example, the optical filter 220 and its corresponding corrector 320 are incorporated directly into the aperture 216 and supported as a filter-corrector pair FC by the body 211 of the support member 210 at the inside edge of the aperture.

In another example, the optical filter 220 and corrector 320 can be cemented together on their faces using a transparent optical cement like that used to cement lens elements to form achromatic doublet lenses. This cemented filter-corrector assembly can be mounted in either manner described above.

In the examples shown in FIGS. 8A through 8C, the corrector 320 has the form of a glass plate 321 having substantially planar front and back surfaces 322 and 324. Here, “substantially planar” means planar to within the design tolerances used to fabricate glass plates for use as optical components. The correctors 320 are configured to correct for the chromatic aberration of the focusing lens 92 at select wavelengths within the light-source wavelength band B as described in greater detail below.

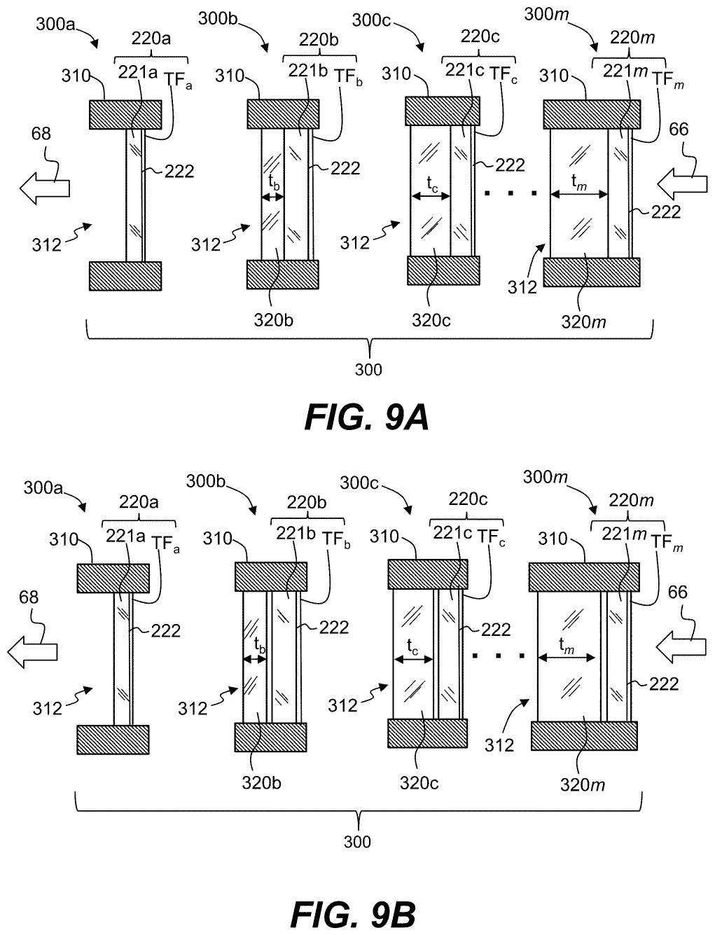

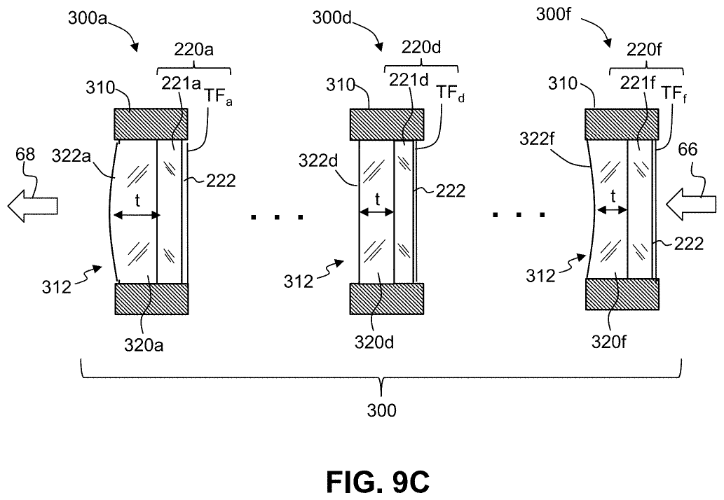

FIG. 9A shows cross-sectional views of a set of m optical filter assemblies 300, denoted 300a, 300b, 300c, . . . 300m, similar to that shown in FIG. 8A. The first optical filter assembly 300a includes an optical filter 220a with a filter substrate 221a and multilayer thin-film TFₐ formed on the front surface 222 of the filter substrate. The optical filter 220a is configured to form the substantially monochromatic filtered light beam 68 (λₐ) having the filter wavelength λₐ and supported by itself in its support frame 310. The second optical filter assembly 300b includes an optical filter 220b with filter substrate 221b and multilayer thin-film TF_{b} formed on the front surface 222 of the filter substrate. The optical filter 220b is configured to form the substantially monochromatic filtered light beam 68 (λ_{b}) at the filter wavelength λ_{b} and also includes a corrector 320b of thickness t_{b}. The third optical filter assembly 300c includes an optical filter 220c with filter substrate 221c and multilayer thin-film TF_{c} formed on the front surface 222 of the filter substrate. The optical filter 220c is configured to form the substantially monochromatic filtered light beam 68(λ_{c}) at the filter wavelength λ_{c} and also includes a corrector 320c of thickness t_{c}. The ellipsis in FIG. 9A shows that there can be a number m of optical filter assemblies 300, with the m^{th} assembly having an optical filter 220m with filter substrate 221m and multilayer thin-film TFₘ and a corrector 320m of thickness tₘ. Thus, each filter assembly 300 (with the possible exception of one filter assembly such as shown in FIG. 9A), comprises an optical filter 220 and a corresponding corrector 320, i.e., a filter-corrector pair FC.

FIG. 9B is similar to FIG. 9A and shows an example where there is a small gap between the optical filter 220 and the corrector 320 of each filter-corrector pair FC.

In practice, there are two or more optical filter assemblies 300, with between three and six being a useful number for use in the EPCS system 6. One of the optical assemblies 300 can be configured to provide good focus with just the optical filter 200 and not require the use of the corrector 320, such as the optical assembly 300a in FIGS. 9A and 9B. On the other hand, each optical assembly 300 can be designed to have a corrector 320. Such a configuration might be useful for example to provide better inertial balance of the filter wheel 230. The correctors 320 can be made of different glasses having different refractive indices.

Calculating the Thickness t of the Correctors

In an example, the corrective properties of a given corrector 320 are based mainly on the refractive index n_{P} and the thickness t. The thickness t is calculated so that the focal position of the filtered light beam 68 at the specific filter wavelength λ is substantially the same as that for all the other optical filter assemblies in the filter wheel 230 for the different filter wavelengths.

In one example, the corrector thickness t is calculated according to the formula:

t=dz/(n_{P}−1)

where as noted above, t is the plate thickness, dz is the change in the distance to the focal position at the given filter wavelength, and n_{P} is the refractive index of the corrector 320 at the given filter wavelength λ. In cases where the filter substrate thickness t′ is sufficiently large to make a difference in correcting chromatic aberration, this filter substrate thickness along with the filter substrate refractive index n_{fs} can be accounted for in the above thickness calculation as follows:

dz−t′(n_{fs}−1)]/[(n_{P}−1)]

In the examples of FIGS. 9A and 9B, the filter wavelength decreases moving from the optical filter assembly 300a toward the optical filter assembly 300m, thereby requiring increasingly greater values for the thickness t of the corrector 320.

Table 1 below sets forth example design parameters for a set of six optical filter assemblies for a configuration of the collection optical system 90 wherein the focusing lens 92 is a singlet made of N-BK7 glass having a focal length of f=166 mm at a wavelength of 790 nm. The glass type for each of the correctors 320 is N-LAF33, which has a relatively high refractive index n_{P} so that the thickness t of each plate can be smaller as compared to using a relatively low refractive index glass such as quartz or N-BK7. For this Table it is assumed the filter substrate thickness t′ can be ignored.

TABLE 1

| λ (nm) | dz (mm) | n_{P} | t (mm) |
|---|---|---|---|
| λ_{f} = 365 | 7.73 | 1.83 | 17.5 |
| λ_{d} = 450 | 4.39 | 1.80 | 10.3 |
| λ_{d} = 545 | 3.07 | 1.79 | 5.7 |
| λ_{c} = 590 | 1.66 | 1.79 | 4.2 |
| λ_{b} = 640 | 1.06 | 1.78 | 2.9 |
| λₐ = 790 | 0.00 | 1.77 | 0.0 |

The data in Table 1 shows that that six different filter wavelengths λₐ through λ_{f} are considered, with the filter wavelength λₐ of 790 nm in the infrared, representing the wavelength at which no optical correction is required so that no corrector is used, such as in the optical filter assembly 300a of FIGS. 9A and 9B. The other five filter wavelengths have increasingly larger thicknesses t as the filter wavelength is reduced, with the maximum thickness t being 17.5 mm at the lowest (smallest) filter wavelength λ of 365 nm in the UV.

For collecting mode spectrum data in the EPCS system 6 at all six wavelengths in Table 1, a filter wheel 230 with six different optical filter assemblies 300 (300a through 300f) would be employed, wherein the optical filter assembly 300a corresponding to filter wavelength of 790 nm can include only the corresponding optical filter 220a since as noted above no focus compensation is needed at this wavelength (t=0).

Correctors with Optical Power

FIG. 9C is similar to FIG. 9A and illustrates an embodiment where the back surface 324 (i.e., the surface opposite the corresponding optical filter 220) of at least some of the correctors 320 have a slight amount of curvature so that the correctors also serve as weak lenses, i.e., the correctors have relatively small amounts of optical power. Table 2 below sets forth an example configuration of the collection optical system 90 for a single focusing lens 92 made of N-BK7 glass and having a focal length of 166 mm at 790 nm, and wherein each corrector 320 is made of N-BK7 and has the same thickness t of 3 mm. The sag and fringes are calculated for 633 nm. The radii of curvature R (mm) are selected to correct the chromatic aberration of the focusing lens 92 for the given wavelength.

TABLE 2

| λ (nm) | dz (nm) | R (mm) | Sag (μm) | Fringes |
|---|---|---|---|---|
| λ_{f} = 365 | 7.73 | −1.9E+03 | −6.6 | 20.8 |
| λₑ = 450 | 4.39 | −5.0E+03 | −2.5 | 7.9 |
| λ_{d} = 545 | 3.07 | infinite | 0.0 | 0.0 |
| λ_{c} = 590 | 1.66 | 1.5E+04 | 0.8 | 2.6 |
| λ_{b} = 640 | 1.06 | 8.1E+03 | 1.5 | 4.9 |
| λₐ = 790 | 0.00 | 4.0E+03 | 3.1 | 9.9 |

In the example configuration of Table 2, the filter wavelength of λ_{d}=545 nm has been selected to use a flat rear surface 322, which corresponds to an infinite radius of curvature R, as shown in the middle optical filter assembly 300d of FIG. 9C. The radii of curvature R for the wavelengths smaller than λ_{d}=545 nm are negative while the radii of curvature R for the wavelengths greater than λ_{d}=545 nm are positive.

As can be seen from Table 2, the magnitudes of the radii of curvature R are quite large (i.e., greater than 1 meter). Such curvatures are not easy to control with high precision as compared to controlling the corrector thickness t, so it may be preferred to keep the front and back surfaces 322 and 324 curvatures substantially planar (i.e., to within fabrication tolerances) and vary the plate thickness to achieve correction, such as described above. In an example, the magnitude of the radii of curvature R of a lens-type corrector 320 is greater than 500 mm.

Method of Operating the Focus-Corrected Optical Filter Apparatus

With reference again to FIGS. 5A and 5B, the focus-corrected optical filter apparatus 300 operates by the drive motor 250 or like drive system being mechanically connected to the filter wheel 230, e.g., via the drive shaft 244 as shown in the example configuration. The drive motor 250 causes the filter wheel 230 to rotate about the rotation axis AR, thereby causing the filter assemblies 300a, 300b, . . . to sequentially intersect the focused light beam 66. This causes the focused light beam 66 to be sequentially wavelength filtered to form the sequentially filtered light beams 68, which are sequentially detected by the detector 110.

The data signal SF sent from the focus-corrected optical filter apparatus 200 to the controller 150 provides information to the controller about the rotational position of the filter wheel 230 and thus which optical filter assembly 300 is performing optical filtering on the reflected light beam 62R at a given time. This allows for the mode spectra 113 to be detected and measured at the different filter wavelengths within the light-source wavelength band B, which in turn allows for a more complete and/or accurate characterization of the stress characteristics of the CS article 10 being measured.

The data detection rate of the EPCS system 6 is limited mainly by the the brightness of the measurement light beam 62 generated by light source system 60 since the photodetector system 130 has a minimum exposure time for obtaining a suitable mode spectrum image. An example data detection rate (measurement throughput) for a set of six filter wavelengths is 1 second per measurement for all six wavelengths. Other measurement rates are possible and this particular measurement rate is discussed as a non-limiting example. Increasing the brightness (radiance) of the light source system 60 can be used to increase the measurement rate.

Alternate Configurations of the Focus-Corrected Optical Filter Apparatus

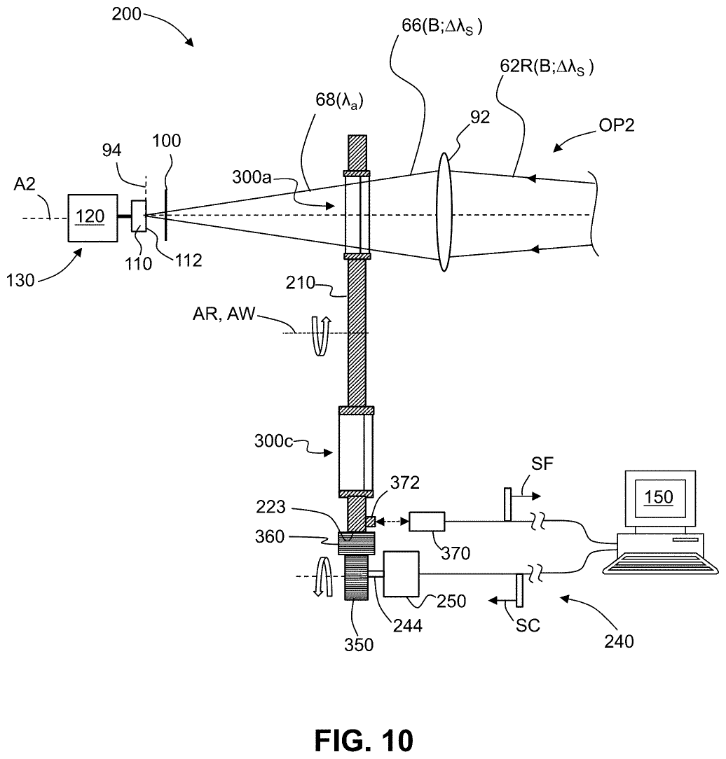

FIG. 10 is similar to FIG. 5A and illustrates an alternate configuration for the drive system 240 for driving the rotation of the filter wheel 230 in the focus-corrected optical filter apparatus 200. The example configuration of the drive system 240 of FIG. 10 utilizes a drive gear 350 that engages a gear 360 that runs around the perimeter 223 of the support member 220 of the filter wheel 230. The drive shaft 244 connected to the drive motor 250 is used to drive the drive gear 350, which in turn drives the rotation of the filter wheel 230. In an example, a position sensor 370 can be used to measure the angular position of the filter wheel 230. The position sensor 370 can be a non-contact sensor that senses one or more features (e.g., indicia) 372 on the filter wheel 230 and sends the position information in the data signal SF sent to the controller 150. Other drive systems 240 can also be effectively employed and the two drive systems disclosed herein are provided by way of example.

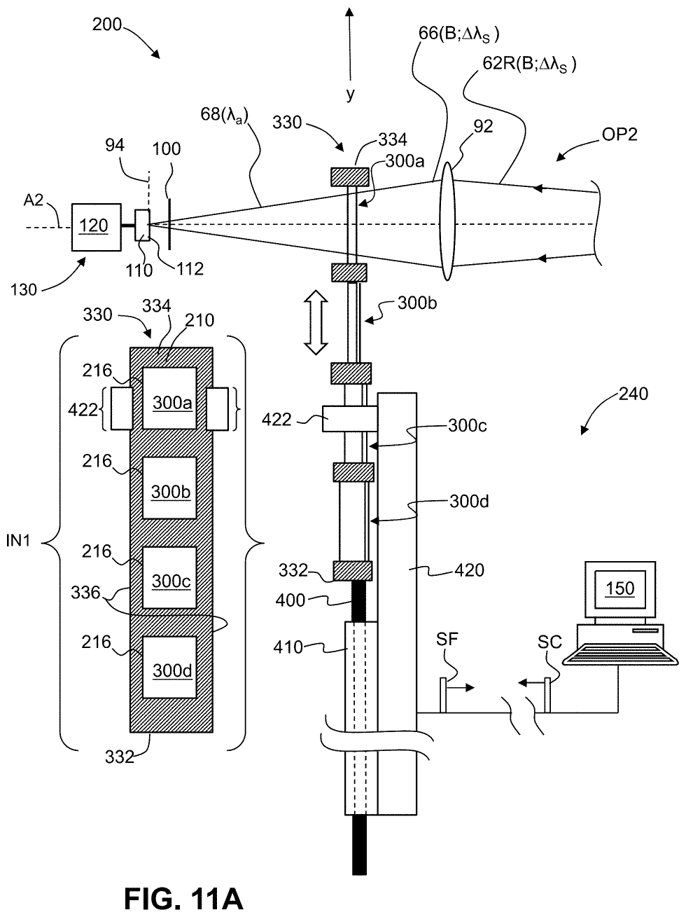

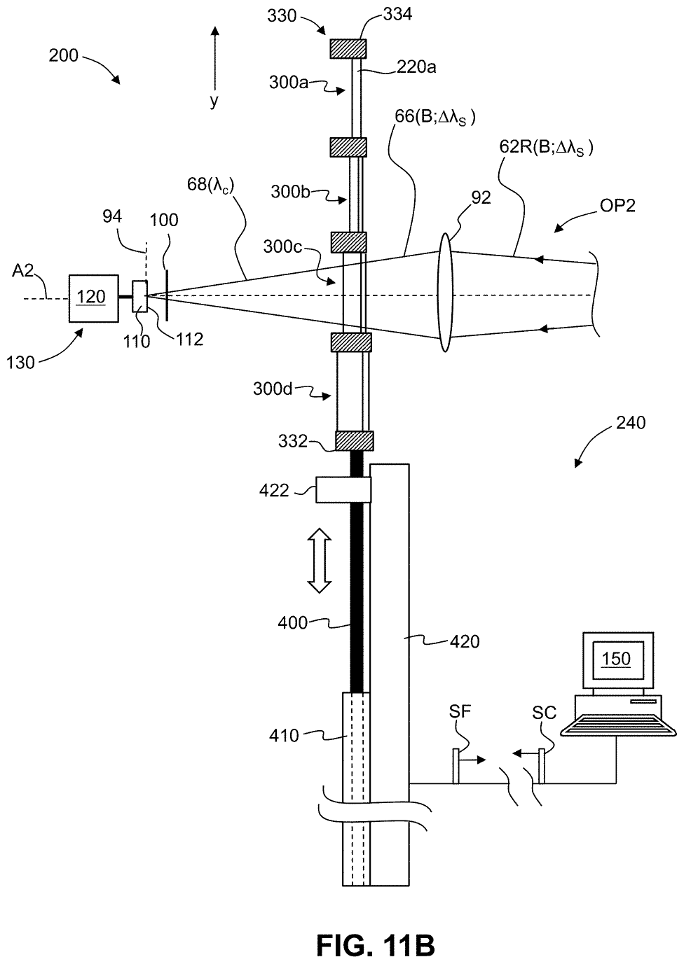

FIG. 11A shows a configuration of the focus-corrected optical filter apparatus 200 wherein the support member 210 is elongate and supports the optical filter assemblies 300 (300a through 300d) in apertures 216 to form a linear array of the optical filter assemblies, as shown in the close-up inset IN1 of FIG. 11A. The optical filter assemblies 300 are shown as square but could also be round, rectangular, etc. In this example, the combination of the support member 210 and optical filter assemblies 200 constitute a filter bar 330 having opposite ends 332 and 334 and opposite sides 336. The filter bar 330 is operably engaged at end 332 by a drive member 400 of a linear drive device 410, such as a linear actuator or linear motor. The linear drive device 410 is supported by a base 420 that can optionally include a guide feature 422 configured to guide the filter bar 330 (e.g., at its opposite sides 336) as it moves (an example guide feature is also shown in the close-up inset IN1). The linear drive device 410 moves the filter bar 330 by causing the drive member to move along its length (i.e., in the local y-direction, as shown), thereby sequentially placing the optical filter assemblies into the optical path OP2 of the reflected light beam 62R.

FIG. 11B is similar to FIG. 11A but shows the focus-corrected optical filter apparatus 200 later in time wherein the drive member 400 has been extended further from the linear drive device 410 so that now a different optical filter assembly 300 (namely, 300c) is now in the optical path OP2 to filter the focused light beam 66. The linear drive device 410 moves the filter bar 330 back and forth in the y-direction under the direction of the controller 150 via the control signal SC to continue the measurement process using the EPCS system 6. The linear drive device 410 generates the data signal SF that includes information about the linear position of the filter bar 330 relative to the optical path OP2 to indicate which optical filter assembly 300 resides in the optical path OP2 at a given time.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A focus-correcting optical filter apparatus for correcting a focus error between sequentially generated substantially monochromatic light beams from a focused polychromatic light beam, comprising:
a movable support member;
a plurality of optical filter assemblies operably supported by the movable support member, with the optical filter assemblies each comprising an optical filter and a corrector optically aligned thereto to form a plurality of filter-corrector pairs, with each optical filter configured to transmit a wavelength of the focused polychromatic light beam substantially different than the other optical filters, and wherein each corrector substantially corrects for the focus error for the wavelength transmitted by the corresponding optical filter in the given filter-corrector pair; and
a drive system mechanically coupled to the movable support member and configured to move the movable support member to sequentially insert the plurality of optical filter assemblies into the focused polychromatic light beam to form the sequentially generated substantially monochromatic light beams having substantially different wavelengths and a common focus.

2. The focus-correcting optical filter apparatus according to claim 1, further comprising a plurality of glass plates each having planar opposite surfaces, an axial thickness, and an index of refraction, with each corrector comprising one of the plurality of glass plates, wherein at least one of the axial thickness and the index of refraction differ between each of the glass plates.

3. The focus-correcting optical filter apparatus according to claim 1, wherein at least one of the correctors comprises a glass plate having a surface with a radius of curvature with a magnitude greater than 500 mm.

4. The focus-correcting optical filter apparatus according to claim 1, wherein the optical filter comprises a multilayer thin-film formed directly on a surface of the corrector.

5. The focus-correcting optical filter apparatus according to claim 1, further comprising an additional optical filter assembly that comprises an optical filter but that does not comprise a corrector.

6. The focus-correcting optical filter apparatus according to claim 1, wherein each of the optical filter assemblies comprises a support frame that supports the corresponding optical filter and corrector.

7. The focus-correcting optical filter apparatus according to claim 1, wherein the movable support member and the plurality of optical filter assemblies constitute an optical filter wheel.

8. The focus-correcting optical filter apparatus according to claim 1, wherein the focused polychromatic light beam comprises an ultraviolet wavelength, a visible wavelength and an infrared wavelength.

9. The focus-correcting optical filter apparatus according to claim 1, further comprising:
a focusing lens configured to receive reflected light reflected from an interface formed by a coupling prism and a waveguide of a chemically strengthened article to form the focused polychromatic light beam, wherein the reflected light contains information about a guided mode spectrum of the waveguide at each of the substantially different wavelengths of the substantially monochromatic light beams.

10. A focus-correcting optical filter apparatus for correcting a focusing error between first and second substantially monochromatic focused light beams having respective first and second wavelengths and formed from a focused polychromatic light beam comprising the first and second wavelengths, the apparatus, comprising:
first and second optical filter assemblies respectively comprising first and second axes and first and second optical filters respectively arranged along the first and second axes and configured to respectively transmit substantially only the first and second wavelengths of the focused polychromatic light beam;
a movable support member that supports the first and second filter assemblies in operable relation to the focused polychromatic light beam to allow for the first and second optical filter assemblies to be sequentially inserted into the focused polychromatic light beam when moving the movable support member to sequentially form the first and second substantially monochromatic light beams;
the first optical filter assembly further comprising a first corrector disposed along the first axis and in a fixed relation to the first optical filter so that the first optical filter and the first corrector move together when moving the movable support member, wherein the first corrector substantially corrects the focusing error between the first and second substantially monochromatic focused light beams; and
a drive system mechanically coupled to the movable support member and configured to move the movable support member to sequentially insert the first and second optical filter assemblies into the focused polychromatic light beam to form the first and second substantially monochromatic light beams having substantially different wavelengths.

11. The focus-correcting optical filter apparatus according to claim 10, wherein the first corrector comprises a glass plate having substantially planar surfaces, a thickness, and an index of refraction, and wherein at least one of the thickness and the index of refraction is selected to correct the focusing error.

12. The focus-correcting optical filter apparatus according to claim 10, wherein the first corrector comprises a glass element having a thickness, a substantially planar surface, and a curved surface, wherein the thickness, the index of refraction, and the curved surface are selected to correct the focusing error, and wherein the curved surface has a radius of curvature with a magnitude greater than 500 mm.

13. The focus-correcting optical filter apparatus according to claim 10, wherein the movable support member and first and second filter assemblies comprise either a rotatable filter wheel or a filter bar.

14. The focus-correcting optical filter apparatus according to claim 10, wherein the focused polychromatic light beam comprises additional wavelengths, and further comprising corresponding additional filter assemblies each comprising an additional optical filter and an additional corrector, wherein each additional corrector is configured to correct additional focusing errors between additional substantially monochromatic light beams respectively having the additional wavelengths when the additional filter assemblies are sequentially inserted into the focused polychromatic light beam.

15. The focus-correcting optical filter apparatus according to claim 10, wherein the focused polychromatic light beam comprises an ultraviolet wavelength, a visible wavelength and an infrared wavelength.

16. The focus-correcting optical filter apparatus according to claim 10, further comprising:
a focusing lens configured to receive reflected light reflected from an interface formed by a coupling prism and a waveguide of a chemically strengthened article to form the focused polychromatic light beam, wherein the reflected light contains information about a guided mode spectrum of the waveguide at each of the first and second wavelengths of the first and second substantially monochromatic focused light beams.

17. A method of correcting a focusing error between first and second substantially monochromatic focused light beams having respective first and second wavelengths and formed from a focused multi-wavelength light beam comprising the first and second wavelengths, the method comprising:
a) forming the first substantially monochromatic focused light beam by moving a first optical filter into the focused multi-wavelength light beam to transmit substantially only the first wavelength of the focused multi-wavelength light beam, wherein the first substantially monochromatic light beam focuses at a first focus position; and
b) forming the second substantially monochromatic focused light beam by moving a second optical filter and a second corrector together as a pair into the focused multi-wavelength light beam to transmit substantially only the second wavelength of the focused multi-wavelength light beam, wherein the second substantially monochromatic light beam would focus at a second focus position substantially different from the first position using only the second optical filter, and wherein the corrector causes the second focus position to reside substantially at the first focus position.

18. The method according to claim 17, wherein the focused multi-wavelength light beam comprising a third wavelength, and further comprising:
c) forming a third substantially monochromatic focused light beam by moving a third optical filter and third corrector together as a pair into the focused multi-wavelength light beam to transmit substantially only the third wavelength of the focused multi-wavelength light beam, wherein the third substantially monochromatic light beam would focus at a third focus position substantially different from the first position using only the third optical filter, and wherein the third corrector causes the third focus position to reside substantially at the first focus position.

19. The method according to claim 17, wherein the second corrector comprises a glass plate having substantially planar opposite surfaces, a refractive index, and a thickness, wherein at least one of the refractive index and the thickness is selected to cause the second focus position to reside substantially at the first focus position.

20. The method according to claim 17, further comprising:
directing multi-wavelength light to be incident upon an interface between a coupling prism and a waveguide of a chemically strengthened article to form a reflected multi-wavelength light beam that includes mode spectrum information about the waveguide at each of the first and second wavelengths; and
focusing the reflected multi-wavelength light beam using a focusing lens to form the focused multi-wavelength light beam.
